(19) United States
(12) Patent Application Publication
(10) Pub. No.: US 2023/0340930 A1
(43) Pub. Date: Oct. 26, 2023

(54) TURBORAMJET ENGINE

(71) Applicant: Pradeep DASS, Edmonton (CA)

(72) Inventor: Pradeep DASS, Edmonton (CA)

(21) Appl. No.: 18/025,373

(22) PCT Filed: Sep. 8, 2021
(86) PCT No.: PCT/CA2021/051242

§ 371 Date: Mar. 8, 2023

Related U.S. Application Data
(60) Provisional application No. 63/075,678, filed on Sep. 8, 2020.

(51) Int. Cl. F02K 7/16; F02C 7/141; F02C 9/18

(52) U.S. Cl. CPC F02K 7/16; F02C 7/141; F02C 9/18; F05D 2260/213; F05D 2220/10; F05D 2300/133; F05D 2300/125

(57) ABSTRACT

A turboramjet has a housing with an intake and an exhaust. The housing houses a heat exchanger, a turbojet section and a ramjet section downstream of the turbojet section. The heat exchanger has an air path and a coolant path. The air path is configured to receive air from the air intake. The heat exchanger has a first section made from a first material and a second section made from a second material, the second material having a lower melting point and a lower density relative to the first material. A bypass air passage selectively bypasses the turbojet section to supply air to the ramjet section, and the coolant path uses fuel as a coolant and is configured to supply the fuel to the turbojet section.

### TECHNICAL FIELD

This relates to a turboramjet engine, and in particular a turboramjet engine with an inlet heat exchanger.

### BACKGROUND

Turboramjet engines are a hybrid engine that combine a turbojet and a ramjet in a common housing. The turbojet is typically used at low speeds while the ramjet is typically used at high speeds. An example of a turboramjet engine is given in U.S. Pat. No. 5,148,673 (Enderle) entitled “Integrated Turboramjet Engine”.

### SUMMARY

According to an aspect, there is provided a turboramjet engine, comprising a housing having an air intake and an exhaust, wherein the housing houses a heat exchanger having an air path and a coolant path, the air path configured to receive air from the air intake, the heat exchanger having a first section made from a first material and a second section made from a second material, the second material having a lower melting point and a lower density relative to the first material, a turbojet section configured to receive air from the air path of the heat exchanger, a ramjet section downstream from the turbojet section, a bypass air passage that selectively bypasses the turbojet section to supply air to the ramjet section, and wherein the coolant path uses fuel as a coolant and is configured to supply the fuel to the turbojet section.

According to other aspects, the turboramjet engine may comprise one or more of the following features, alone or in combination: the turboramjet engine may further comprise a fuel supply system that selectively connects a fuel source to the coolant path, the ramjet section, or both the coolant path and the ramjet section; the fuel source may comprise a cryogenic fuel; the fuel supply system may comprise an alternate fuel conduit connected between an alternate fuel source and the turbojet section; the coolant path selectively cools the air path; the first material may comprise titanium and the second material may comprise a magnesium alloy; a fuel in the fuel conduit may flow in an opposite direction of air in the heat exchanger; a flow area of the bypass channel may be variable; and the fuel source may be liquid hydrogen.

According to an aspect, there is provided a method of using a turboramjet engine, the method comprising using a heat exchanger, cooling air and warming a cryogenic fuel, the heat exchanger comprising an air path and a coolant path, the air being cooled in the air path, the heat exchanger having a first section made from a first material and a second section made from a second material, the second material having a lower melting point and a lower density relative to the first material, and mixing and combusting the cooled air and the warmed cryogenic fuel in a turbojet section, a ramjet section, or both the turbojet section and ramjet section of the turboramjet engine.

According to other aspects, the method may comprise one or more of the following features, alone or in combination: the first material may be titanium, and the second material may be a magnesium alloy; the method may further comprise the step of driving the turbojet section using an alternate fuel; and the method may further comprise the step of causing the air to bypass the heat exchanger, and be combusted with the warmed cryogenic fuel in the ramjet section.

In other aspects, the features described above may be combined together in any reasonable combination as will be recognized by those skilled in the art.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic view of a turboramjet engine.

FIG. 2 is a schematic view of a heat exchanger of a turboramjet engine.

FIG. 3 is a schematic view of a turbojet section and a ramjet section of a turboramjet engine.

FIG. 4 is a schematic view of a turboramjet engine identifying regions of interest.

FIG. 5 is a schematic view of an alternate embodiment of a turboramjet engine operating in a turbojet mode.

FIG. 6 is a plot of altitude and net thrust as a function of Mach number for an alternate embodiment of a turboramjet engine operating in a turbojet mode.

FIG. 7 is a plot of altitude and air mass flow as a function of Mach number for an alternate embodiment of a turboramjet engine operating in a turbojet mode.

FIG. 8 is a plot of altitude and specific fuel consumption as a function of Mach number for an alternate embodiment of a turboramjet engine operating in a turbojet mode.

FIG. 9 is a plot of heat exchanger pressure ratio and temperature drop as a function of Mach number for an alternate embodiment of a turboramjet engine operating in a turbojet mode.

FIG. 10 is a schematic view of an alternate embodiment of a turboramjet engine operating in a ramjet mode.

FIG. 11 is a plot of altitude and net thrust as a function of Mach number for an alternate embodiment of a turboramjet engine operating in a ramjet mode.

FIG. 12 is a plot of altitude and air mass flow as a function of Mach number for an alternate embodiment of a turboramjet engine operating in a ramjet mode.

FIG. 13 is a plot of altitude and specific fuel consumption as a function of Mach number for an alternate embodiment of a turboramjet engine operating in a ramjet mode.

### DETAILED DESCRIPTION OF PREFERRED EMBODIMENTS

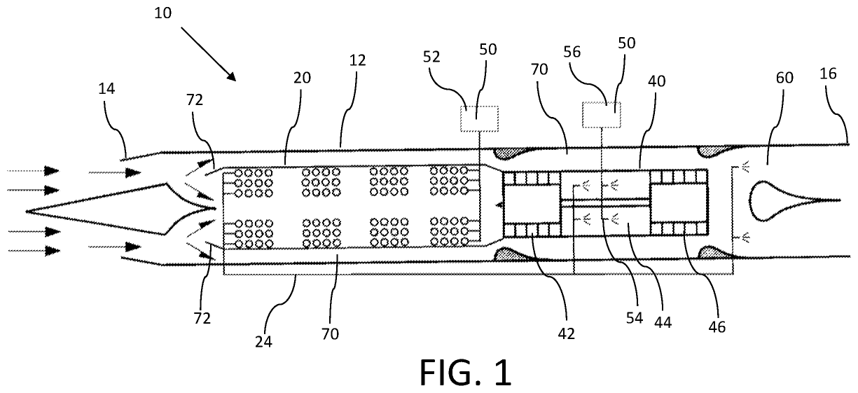

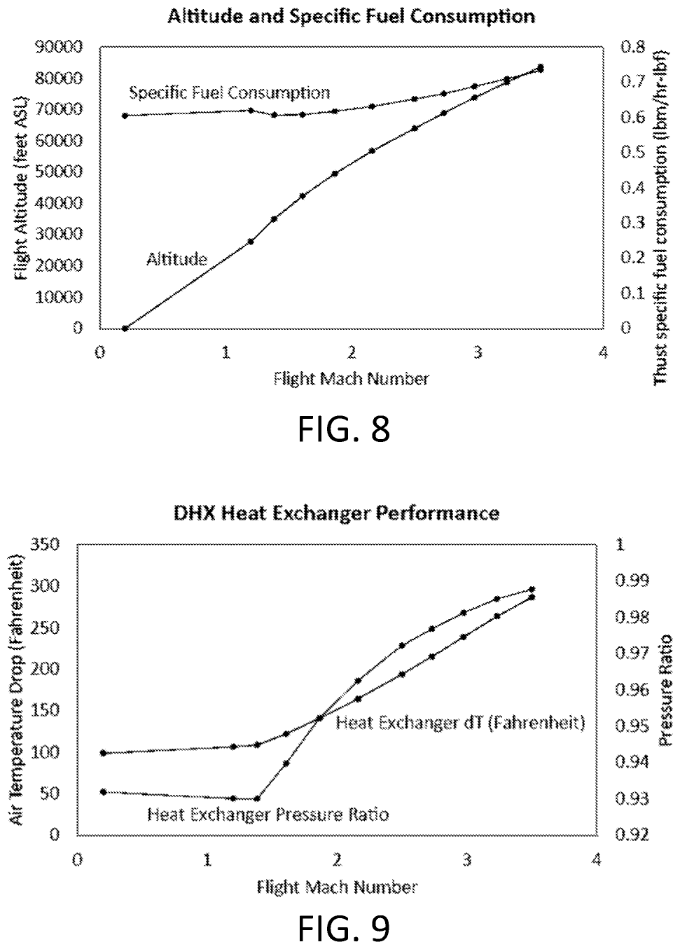

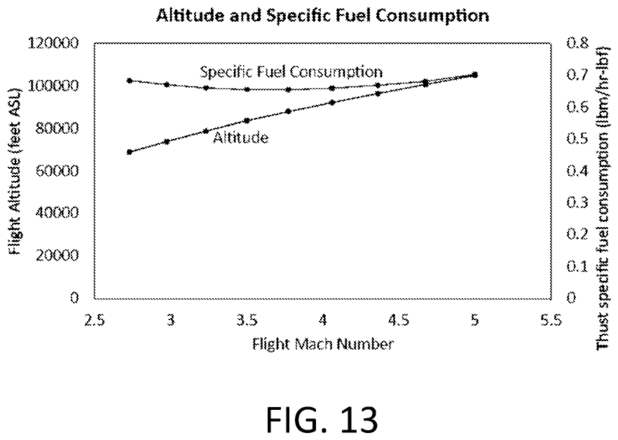

A turboramjet engine, generally identified by reference numeral 10, will now be described with reference to FIG. 1 through 13. Turboramjet engine 10 is designed to provide thrust to a supersonic aircraft using, at least in part, a cryogenic fuel.

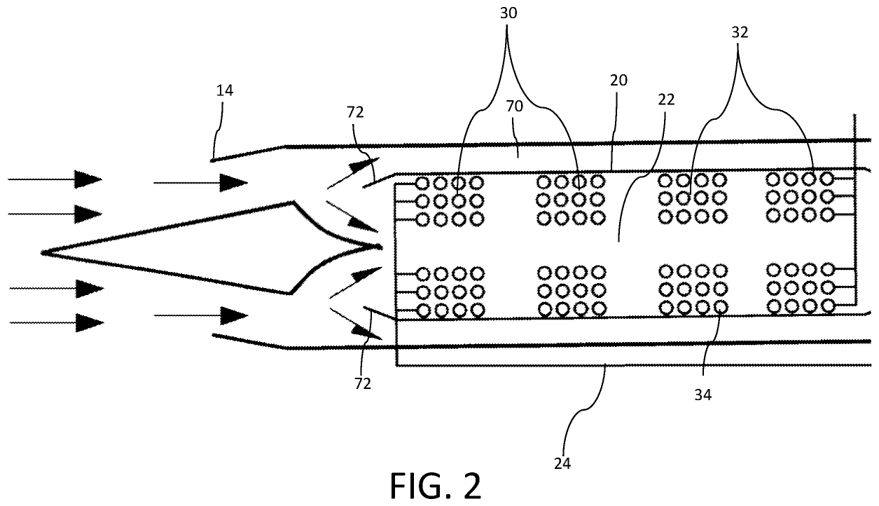

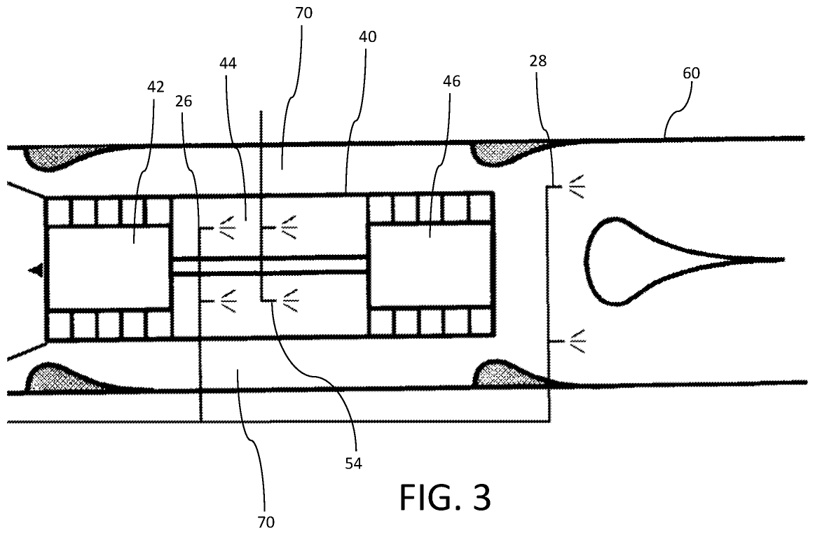

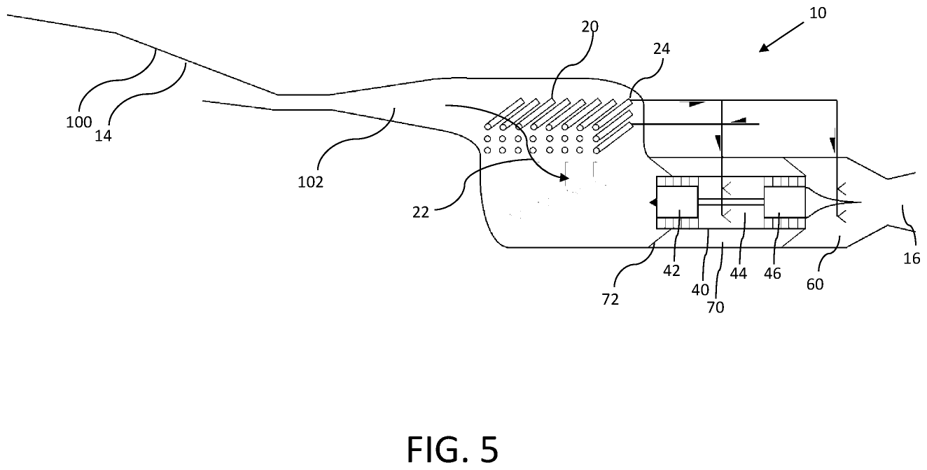

Referring to FIG. 1, turboramjet engine 10 has a housing 12 with an air intake 14 and an exhaust 16. Housing 12 houses a heat exchanger 20, a turbojet section 40, and a ramjet section 60. Housing 20 may be generally cylindrical in shape, with a circular intake 14 aperture, as shown in FIG. 1, or may have other shapes, such as the shape shown in FIG. 5. As the operation of turboramjet engines is well known, only a brief, non-exhaustive discussion will be given. Referring to FIG. 2, heat exchanger 20 is configured to receive air from intake 14, which is cooled in heart exchanger 20. Referring to FIG. 3, air cooled in heat exchanger 20 is passed into turbojet section 40. Turbojet section 40 has a compressor 42, a combustion chamber 44, and a turbine 46. Combustion air is compressed by compressor 42 into combustion chamber 44, where fuel is combusted to create thrust, which also drives turbine 46.

Ramjet section 60 is located downstream from turbojet section 40. When in the ramjet mode, a bypass air passage 70 may be used to bypass turbojet section 40 and supply air to ramjet section 60. Turbojet section 40 and ramjet section 60 may be operated independently to provide thrust, or simultaneously, such as by using ramjet section 60 as an afterburner to turbojet section 40.

Referring to FIG. 2, heat exchanger 20 has an air path 22 through which air received from inlet 14 passes, and a coolant path 24 which exchanges heat with the air path. Coolant path 24 uses fuel as a coolant and is configured to supply fuel to turbojet section 40, specifically delivering fuel through a first outlet 26 within combustion chamber 44. The fuel may be a cryogenic fuel, such as liquid hydrogen, that is allowed to expand into gaseous hydrogen as it passes through heat exchanger 20. Coolant path 24 may deliver fuel to ramjet section 60 through a second outlet 28.

Heat exchanger 20 has a first section 30 made from a first material and a second section 32 made from a second material, where first section 30 is located upstream of second section 32. Second section 32 is made from a material with a lower melting point and lower density relative to the first material. In one example, the first section is made from titanium or a titanium alloy, and the second section is made from a magnesium alloy. The use of a magnesium alloy for a portion of heat exchanger 20 may allow for turboramjet engine 10 to be lighter relative to a similar turboramjet made only from titanium, while also remaining resistant to the heat generated by gas entering intake 14 due to the use of heat exchanger 20. Heat exchanger 20 may have more than two sections and may have more than two materials. For example, other metals with suitable melting points and densities, such as aluminium, may be incorporated into heat exchanger 20. By designing heat exchanger 20 in this manner, the weight of heat exchanger 20 may be reduced by using a lighter metal that has a lower melting point relative to the metal used in the upstream portions of heat exchanger 20, where higher temperatures will be encountered.

As shown, heat exchanger 20 may have a plurality of exchanger tube bundles 34, where a certain number of the bundles make up first section 30, and the remaining bundles make up second section 32. The number of bundles and relative sizes of sections 30 and 32 may vary, and there may be an intermediate section between sections 30 and 32 of an intermediate metal selected for a desired melting temperature and density. In the depicted example, coolant fuel enters heat exchanger 20 adjacent to turbojet section 70 and flows in a direction opposite the flow of air in air path 22, such that the heat gradient of heat exchanger 20 is warmer toward air inlet 14 and is cooler closer to turbojet section 70, similar to the combustion air. As such, in the depicted example, coolant fuel travels through second section 32 before first section 30, before being injected into combustion chamber 44.

Turboramjet engine 10 may have a fuel supply system 50 that connects a fuel source 52 to coolant path 24, ramjet section 60, or both coolant path 24 and ramjet section 60. Fuel supply system 50 may also have an alternate fuel conduit 54 that connects an alternate fuel source 56 to turbojet section 40. Alternate fuel source 56 may be jet fuel, as will be discussed below.

Bypass air passage 70 may be used to supply air from intake 14 to ramjet section 60 without passing through turbojet section 40. Referring to FIG. 1, bypass air passage 70 may also bypass heat exchanger 20. Alternatively, bypass air passage 70 may bypass turbojet section 40 after passing through air passage 22 of heat exchanger 20. Valves 72 may be provided along a length of turboramjet engine 10 that selectively open or close bypass air passage 70, heat exchanger 20, or turbojet section 40 to air from intake 14 to control airflow through housing 12. A flow area of bypass air channel 70 may be variable to control the amount of air allowed through bypass air channel 70.

A method of using turboramjet engine 10 will now be described.

Turboramjet engine 10 may operate in phases, with fuel being supplied to and combusted in the various sections of turboramjet engine 10 depending on operating conditions, such as speed, altitude, air pressure within housing 12, or other relevant conditions. In one example, in a first phase, turbojet section 40 may be operated using a jet fuel, such as jet-A fuel, to provide initial thrust. This phase may be useful during take-off and while achieving an initial air speed and altitude. In a second phase, a cryogenic fuel, such as liquid hydrogen, passes through coolant path 24 of heat exchanger 20 where it is warmed and vaporized prior to being combusted within combustion chamber 44 in turbojet section 40. Cryogenic fuel may replace the use of jet fuel, although there may be a mixture for a certain period of time during a transition to the second stage. Hydrogen or other fuel may also be supplied to ramjet section 60 for afterburner combustion. The second phase may be useful for increasing speed and reaching a higher altitude. During this phase, the inlet air will be warmed to hotter temperatures as the speed increases. By cooling the inlet air using heat exchanger 20, the aircraft will be able to operate more efficiently and/or for a longer period of time in the second phase, which may be used to increase the efficiency of the aircraft in reaching higher speeds and altitudes.

In a third phase, a mixture of fuel and air is provided to ramjet section 60. Once ramjet section 60 is providing thrust, turbojet section may be closed by valves 72 such that thrust is provided only by combustion in ramjet section 60. There may be a transition period from the second phase to the third phase where both ramjet section 60 and turbojet section provide thrust. Ramjet section 60 allows higher speeds and altitudes to be reached. Air passing through bypass air channel 70 may pass through and be cooled in heat exchanger 20 or may bypass heat exchanger 20. Once ramjet section 60 is operating, fuel may be supplied directly to ramjet section 60 with or without passing through coolant path 24. Fuel may be a cryogenic liquid such as liquid hydrogen, max be a cryogenic liquid that has been warmed to a gas, or may be a different fuel. The first, second, and third phases are generally known, however appropriate use of heat exchanger 20 and cryogenic fuel may permit engine 10 to operate for a longer period of time in the second stage or to operate more efficiently.

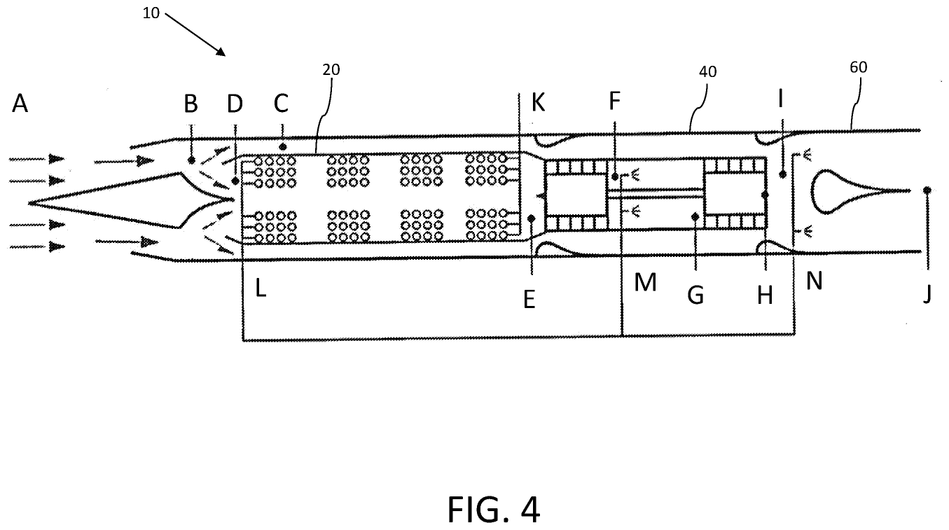

Referring to FIG. 4, an example of turboramjet engine 10 is shown with regions identified by A-N, which correspond to the columns of simulation data identified in the table below, based on the NASA pyCycle model. The table indicates various operating conditions during a model of the second phase of operation at the identified points along engine 10.

| | A | B | C | D | E | F | G |
|---|---|---|---|---|---|---|---|
| Mass flow (kg/s) | N/A | 76.5 | 51 | 25.5 | 25.5 | 25.5 | 25.9 |
| (lb/s) | | 168.3 | 112.2 | 56.1 | 56.1 | 56.1 | 57.0 |
| Pressure (kPaa) | 1.2 | 5.4 | 5.4 | 5.4 | 5.4 | 68.4 | 68.4 |
| (psia) | | 0.783 | 0.783 | 0.783 | 0.783 | 9.40 | 9.40 |
| Temp. (K) | 250 | 900 | 900 | 900 | 300 | 610 | 1850 |
| (F.) | −9.67 | 1160 | 1160 | 1160 | 80.3 | 638 | 2870 |
| Fluid | Air | Air | Air | Air | Air | Air | Comb. |
| | | | | | | | Prod. |
| Phase | Gas | Gas | Gas | Gas | Gas | Gas | Gas |
| | H | I | J | K | L | M | N |
| Mass flow (kg/s) | 25.9 | 76.9 | 78.1 | 1.6 | 1.6 | 0.5 | 1.1 |
| (lb/s) | 57.0 | 169.18 | 171.8 | 3.52 | 3.52 | 1.1 | 2.42 |
| Pressure (kPaa) | 1.2 | 1.2 | 1.2 | 750 | 750 | 750 | 750 |
| (psia) | 0.174 | 0.174 | 0.174 | 109 | 109 | 109 | 109 |
| Temp. (K) | 465 | 745 | 2550 | 20 | 673 | 673 | 673 |
| (F.) | 377 | 881 | 4130 | −424 | 752 | 752 | 752 |
| Fluid | Comb | Air & | Comb. | H2 | H2 | H2 | H2 |
| | Prod. | Comb. | Prod. | | | | |
| | | Prod. | | | | | |
| Phase | Gas | Gas | Gas | Liquid | Gas | Gas | Gas |

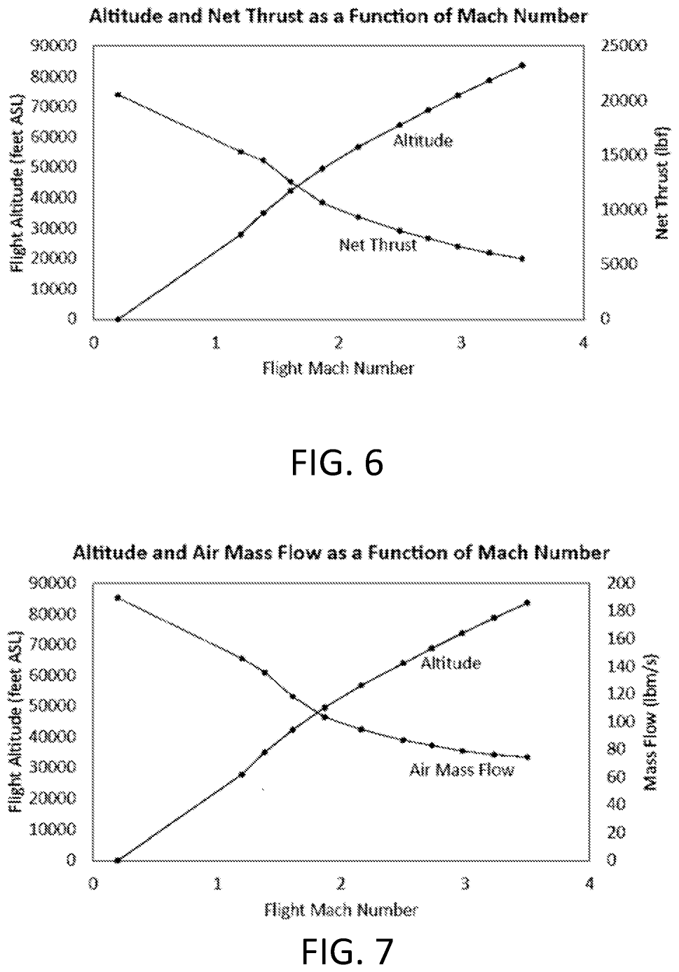

Another example of a turboramjet engine is shown in FIG. 5, where inlet 14 is designed as a supersonic ramp inlet 100 with a diffuser 102 to disperse air upstream of heat exchanger 20. FIG. 6 through FIG. 9 provide plots obtained through a simulation of the various operating conditions of turbojet section 40. In addition, a simulation of air temperatures within different portions of the example shown in FIG. 5 of turboramjet engine 10 in the table below as the speed and altitude increases while operating using turbojet section 40.

Temperature (Fahrenheit)

| Mach | Altitude | | | Heat | |
|---|---|---|---|---|---|
| Number | (ft) | Inlet | Diffuser | Exchanger | Compressor |
| 0.2 | 0 | 52.4 | 63.2 | −66.7 | 599 |
| 1.2 | 27887 | 2.24 | 80.5 | −58.8 | 592 |
| 1.4 | 35105 | 5.03 | 85.2 | −56.2 | 595 |
| 1.6 | 42323 | 48.7 | 133 | −15.9 | 614 |
| 1.9 | 49541 | 115 | 202 | 40.7 | 661 |
| 2.2 | 56759 | 201 | 294 | 113 | 734 |
| 2.5 | 63976 | 312 | 416 | 209 | 825 |
| 2.7 | 68898 | 397 | 512 | 285 | 901 |
| 3 | 73819 | 494 | 624 | 375 | 985 |
| 3.2 | 78740 | 602 | 752 | 478 | 1075 |
| 3.5 | 83661 | 718 | 894 | 599 | 1183 |
| Mach | Altitude | | | | |
| Number | (ft) | Combustor | Turbine | Afterburner | Nozzle |
| 0.2 | 0 | 1795 | 1154 | 2823 | 2108 |
| 1.2 | 27887 | 1796 | 1132 | 2806 | 1673 |
| 1.4 | 35105 | 1795 | 1132 | 2805 | 1552 |
| 1.6 | 42323 | 1795 | 1146 | 2817 | 1453 |
| 1.9 | 49541 | 1795 | 1150 | 2824 | 1362 |
| 2.2 | 56759 | 1795 | 1146 | 2825 | 1262 |
| 2.5 | 63976 | 1795 | 1147 | 2830 | 1164 |
| 2.7 | 68898 | 1796 | 1144 | 2833 | 1094 |
| 3 | 73819 | 1796 | 1148 | 2841 | 1032 |
| 3.2 | 78740 | 1796 | 1159 | 2857 | 962 |
| 3.5 | 83661 | 1796 | 1170 | 2874 | 890 |

The air pressure within various portions of turboramjet engine 10 is shown in the table below.

Total Pressure (psia)

| Mach | Altitude | | | Heat | |
|---|---|---|---|---|---|
| Number | (ft) | Inlet | Diffuser | Exchanger | Compressor |
| 0.2 | 0 | 15.0 | 14.3 | 13.3 | 202 |
| 1.2 | 27887 | 11.6 | 11.0 | 10.3 | 158 |
| 1.4 | 35105 | 10.8 | 10.3 | 9.6 | 148 |
| 1.6 | 42323 | 10.6 | 10.1 | 9.5 | 128 |
| 1.9 | 49541 | 11.0 | 10.4 | 9.9 | 112 |
| 2.2 | 56759 | 12.0 | 11.4 | 11.0 | 103 |
| 2.5 | 63976 | 13.8 | 13.1 | 12.7 | 94.2 |
| 2.7 | 68898 | 15.2 | 14.4 | 14.1 | 90.3 |
| 3 | 73819 | 17.0 | 16.1 | 15.8 | 86.1 |
| 3.2 | 78740 | 19.4 | 18.4 | 18.2 | 83.0 |
| 3.5 | 83661 | 22.2 | 21.0 | 20.8 | 81.2 |
| Mach | Altitude | | | | |
| Number | (ft) | Combustor | Turbine | Afterburner | Nozzle |
| 0.2 | 0 | 198 | 52.8 | 49.6 | 49.6 |
| 1.2 | 27887 | 153 | 38.4 | 36.1 | 36.1 |
| 1.4 | 35105 | 142 | 35.5 | 33.4 | 33.4 |
| 1.6 | 42323 | 123 | 31.6 | 29.7 | 29.7 |
| 1.9 | 49541 | 108 | 27.6 | 26.0 | 26.0 |
| 2.2 | 56759 | 98.3 | 24.7 | 23.3 | 23.3 |
| 2.5 | 63976 | 90.4 | 22.4 | 21.1 | 21.1 |
| 2.7 | 68898 | 86.7 | 21.2 | 19.9 | 19.9 |
| 3 | 73819 | 82.6 | 20.0 | 18.8 | 18.8 |
| 3.2 | 78740 | 79.6 | 19.5 | 18.4 | 18.4 |
| 3.5 | 83661 | 77.9 | 19.3 | 18.2 | 18.2 |

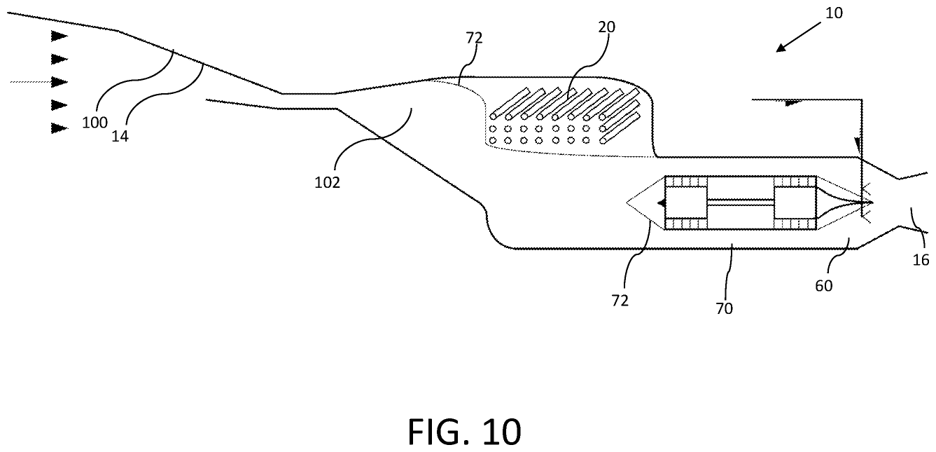

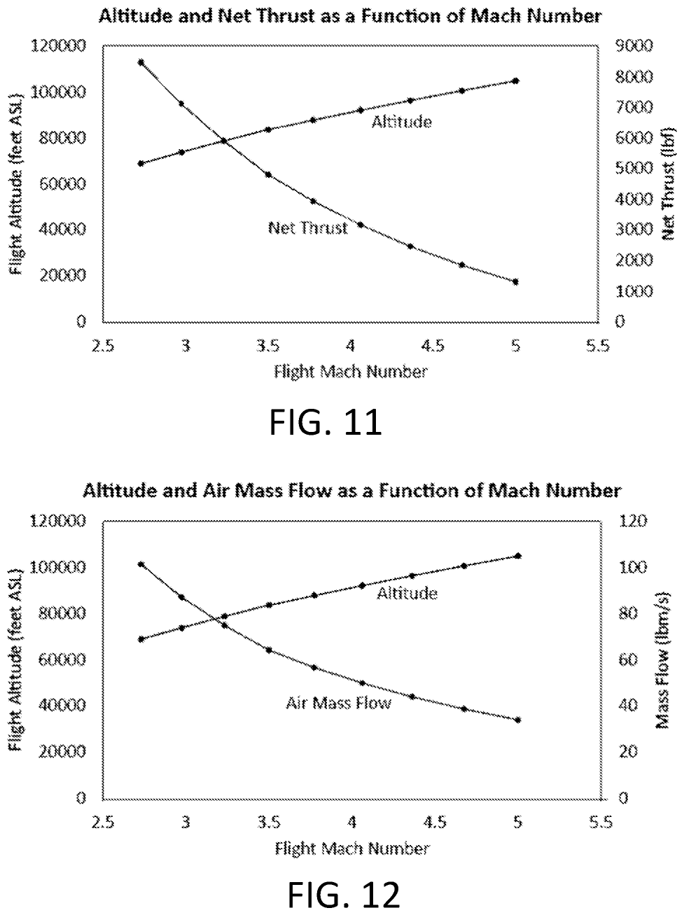

FIG. 10 depicts turboramjet engine 10 operating using ramjet section 40, where heat exchanger 20 and turbojet section 40 are bypassed, while FIG. 11 through 13 are plots of corresponding simulation data for turbojet operation. The temperature within various sections of engine 10 is shown in the table below, as engine 10 transitions to operating as a turbojet engine to operating as a ramjet engine. This may occur at the highest flight speed possible, such as up to Mach 3.5 to maximize engine operating efficiency. The transition point will be a function of altitude and thrust requirement, where higher altitudes and thrust demands may require an earlier transition.

Temperature (Fahrenheit)

| Mach Number | Altitude (ft) | Inlet | Diffuser | Combustor | Nozzle |
|---|---|---|---|---|---|
| 2.7 | 68898 | 395.9 | 497.1 | 2600.1 | 1281.7 |
| 3.0 | 73819 | 493.4 | 613.8 | 2825.8 | 1135.9 |
| 3.2 | 78740 | 600.6 | 744.2 | 2884.6 | 994.3 |
| 3.5 | 83661 | 717.2 | 888.7 | 2910.8 | 861.5 |
| 3.8 | 87927 | 845.2 | 1044.0 | 2923.9 | 743.4 |
| 4.1 | 92192 | 1002.4 | 1216.8 | 2930.9 | 636.4 |
| 4.4 | 96457 | 1199.1 | 1408.3 | 2934.8 | 537.9 |
| 4.7 | 100722 | 1420.5 | 1619.0 | 2937.3 | 439.8 |
| 5.0 | 104987 | 1682.0 | 1850.5 | 2938.6 | 353.8 |

In this patent document, the word “comprising” is used in its non-limning sense to mean that items following the word are included, but items not specifically mentioned are not excluded. A reference to an element by the indefinite article “a” does not exclude the possibility that more than one of the elements is present, unless the context clearly requires that there be one and only one of the elements.

The scope of the following claims should not be limited by the preferred embodiments set forth in the examples above and in the drawings but should be given the broadest interpretation consistent with the description as a whole.

What is claimed is:

1. A turboramjet engine, comprising:
a housing having an air intake and an exhaust, wherein the housing houses:
a heat exchanger having an air path and a coolant path, the air path configured to receive air from the air intake, the heat exchanger having a first section made from a first material and a second section made from a second material, the second material having a lower melting point and a lower density relative to the first material;
a turbojet section configured to receive air from the air path of the heat exchanger;
a ramjet section downstream from the turbojet section;
a bypass air passage that selectively bypasses the turbojet section to supply air to the ramjet section; and
wherein the coolant path uses fuel as a coolant and is configured to supply the fuel to the turbojet section.

2. The turboramjet engine of claim 1, further comprising a fuel supply system that selectively connects a fuel source to the coolant path, the ramjet section, or both the coolant path and the ramjet section.

3. The turboramjet engine of claim 2, wherein the fuel source comprises a cryogenic fuel.

4. The turboramjet engine of claim 2, wherein the fuel supply system comprises an alternate fuel conduit connected between an alternate fuel source and the turbojet section.

5. The turboramjet engine of claim 4, wherein the coolant path selectively cools the air path.

6. The turboramjet engine of claim 3, wherein the first material comprises titanium and the second material comprises a magnesium alloy.

7. The turboramjet engine of claim 1, wherein the fuel in coolant path flows in an opposite direction of air in the heat exchanger.

8. The turboramjet engine of claim 1, wherein a flow area of the bypass channel is variable.

9. The turboramjet engine of claim 3, wherein the fuel source is liquid hydrogen.

10. A method of using a turboramjet engine, the method comprising:
using a heat exchanger, cooling air and warming a cryogenic fuel, the heat exchanger comprising an air path and a coolant path, the air being cooled in the air path, the heat exchanger having a first section made from a first material and a second section made from a second material, the second material having a lower melting point and a lower density relative to the first material; and
mixing and combusting the cooled air and the warmed cryogenic fuel in a turbojet section, a ramjet section, or both the turbojet section and ramjet section of the turboramjet engine.

11. The method of claim 10, wherein the first material is titanium, and the second material is a magnesium alloy.

12. The method of claim 10, further comprising the step of driving the turbojet section using an alternate fuel.

13. The method of claim 10, further comprising the step of causing the air to bypass the heat exchanger, and be combusted with the warmed cryogenic fuel in the ramjet section.
